(19) United States
(12) Patent Application Publication
(10) Pub. No.: US 2026/0065799 A1
(43) Pub. Date: Mar. 5, 2026

(54) APPARATUS AND METHOD FOR AUTOMATIC GENERATION OF MILITARY SCENARIOS

(71) Applicant: NAVIWORKS CO., LTD., Anyang-si (KR)

(72) Inventors: Hyun Woo SIM, Anyang-si (KR); Myung Soo KIM, Anyang-si (KR); Je Hyun NAM, Anyang-si (KR)

(21) Appl. No.: 19/309,925

(22) Filed: Aug. 26, 2025

(30) Foreign Application Priority Data
Aug. 30, 2024 (KR) 10-2024-0117861

(51) Int. Cl. G09B 9/00; G06F 40/154

(52) U.S. Cl. CPC G09B 9/003; G06F 40/154

(57) ABSTRACT

The present disclosure relates to an apparatus and method for automatic generation of military scenarios. An apparatus for automatic generation of military scenarios according to one embodiment of the present disclosure includes a scenario generation unit configured to generate a military scenario in a preset format by applying a large language model to at least one of scenario information, force information, regional information, or event information.

### CROSS-REFERENCE TO RELATED APPLICATION(S)

This present application claims the benefit of priority to Korean Patent Application No. 10-2024-0117861, filed on Aug. 30, 2024, in the Korean Intellectual Property Office, the entire disclosure of which is incorporated herein by reference.

### TECHNICAL FIELD

The present disclosure relates to an apparatus and method for automatic generation of military scenarios, and more particularly, to an apparatus and method for automatic generation of military scenarios that generates military scenarios through a large language model based on natural language input.

### BACKGROUND

Creating sophisticated military scenarios plays a key role in establishing realistic virtual military training or military simulation environments. Existing military simulation systems create scenarios by manually setting and arranging scenario information, force information, regional information, and event information individually, and the scenarios created in this manner are stored in formats tailored to each military simulation system.

However, the scenario creation process is time-consuming due to the many variables and location information that must be considered, and scenarios created in proprietary formats are difficult to use in other military simulations.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

The present disclosure is directed to providing an apparatus and method for automatic generation of military scenarios that generates military scenarios in the standardized Military Scenario Definition Language (MSDL) format through a large language model based solely on natural language input, without requiring users to input additional complex information, for virtual military training.

The present disclosure is further directed to providing an apparatus and method for automatic generation of military scenarios that automatically converts unit branch information contained in a user's natural language input into symbols based on preset military specifications.

The present disclosure is further directed to providing an apparatus and method for automatic generation of military scenarios that enables editing of MSDL using either natural language or direct manual editing, and that provides, in real time, various types of scenario information through a map and user interface (UI), based on the MSDL.

Aspects of the present disclosure are not limited to those mentioned above, and other aspects not mentioned above will be understood from the following description, and become more apparent from the exemplary embodiments. Moreover, aspects of the present disclosure may be realized by the means and combinations thereof indicated in claims.

An apparatus for automatic generation of military scenarios according to one embodiment of the present disclosure may comprise a scenario generation unit configured to generate a military scenario in a preset format by applying a large language model to at least one of scenario information, force information, regional information, or event information.

The apparatus may further comprise a scenario editing unit configured to edit the military scenario by applying the large language model to editing information regarding at least one of the scenario information, the force information, the regional information, or the event information.

The apparatus may further comprise a symbol conversion unit configured to, using a symbol search model, convert unit branch information included in the force information of the military scenario into symbols based on a preset specification corresponding to the unit branch information.

The preset format may be an MSDL-based standard format.

A method for automatic generation of military scenarios according to another embodiment of the present disclosure may comprise generating a military scenario in a preset format by applying a large language model to at least one of scenario information, force information, regional information, or event information.

The method may further comprise editing the military scenario by applying the large language model to editing information regarding at least one of the scenario information, the force information, the regional information, or the event information.

The method may further comprise, using a symbol search model, converting unit branch information included in the force information of the military scenario into symbols based on a preset specification corresponding to the unit branch information.

The preset format may be an MSDL-based standard format.

According to embodiments of the present disclosure, since military scenarios in the standardized Military Scenario Definition Language (MSDL) format are generated and edited through a large language model using natural language input, and maps and a user interface (UI) reflecting the scenarios in real time may be viewed, the compatibility of military scenarios may be improved and the difficulty of creating them may be greatly reduced.

In addition, according to embodiments of the present disclosure, since MSDL is generated by converting unit branch information into symbols based on preset military specifications, it may be utilized by multiple countries and various military organizations.

### BRIEF DESCRIPTION OF THE DRAWINGS

The foregoing and other aspects, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a configuration diagram of an apparatus for automatic generation of military scenarios according to one embodiment of the present disclosure.

FIG. 2 is a flowchart of a method for automatic generation of military scenarios according to one embodiment of the present disclosure.

FIG. 3 is a diagram illustrating a military scenario generated by the apparatus for automatic generation of military scenarios according to one embodiment of the present disclosure.

FIG. 4 is a diagram showing a computing system according to one embodiment of the present disclosure.

### DETAILED DESCRIPTION

Embodiments disclosed in the present specification will be described in greater detail with reference to the accompanying drawings, and throughout the accompanying drawings, the same reference numerals are used to designate the same or similar components and redundant descriptions thereof are omitted. As used herein, the terms “module” and “unit” used to refer to components are used interchangeably in consideration of convenience of explanation, and thus, the terms per se should not be considered as having different meanings or functions. In relation to describing the present disclosure, when the detailed description of the relevant known technology is determined to unnecessarily obscure the gist of the present disclosure, the detailed description may be omitted. Furthermore, it should be understood that the appended drawings are intended only to help understand embodiments disclosed in the present document and do not limit the technical principles and scope of the present disclosure. Rather, it should be understood that the appended drawings include all of the modifications, equivalents or substitutes described by the technical principles and belonging to the technical scope of the present disclosure.

Although the terms first, second, and the like, may be used herein to describe various elements, these elements should not be limited by these terms. These terms are generally only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

Unless otherwise defined, all technical and scientific terms used in the present disclosure have the same meanings as commonly understood by those skilled in the art of this application. The terms “include,” “comprise,” and any variations thereof used in the specification of this application are intended to encompass non-exclusive inclusion.

When a component, unit, device, element, apparatus, or the like of the present disclosure is described as having a purpose or performing an operation, function, or the like, the component, unit, device, element, apparatus, or the like should be considered herein as being “configured to” meet that purpose or to perform that operation or function. Each component, unit, device, element, apparatus, and the like may separately embody or be included with a processor and a memory, such as a non-transitory computer readable media, as part of the apparatus.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

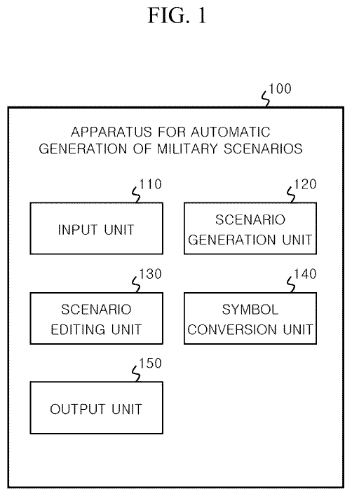

Hereinafter, an apparatus and method for automatic generation of military scenarios according to embodiments of the present disclosure will be described in detail with reference to FIGS. 1 to 4.

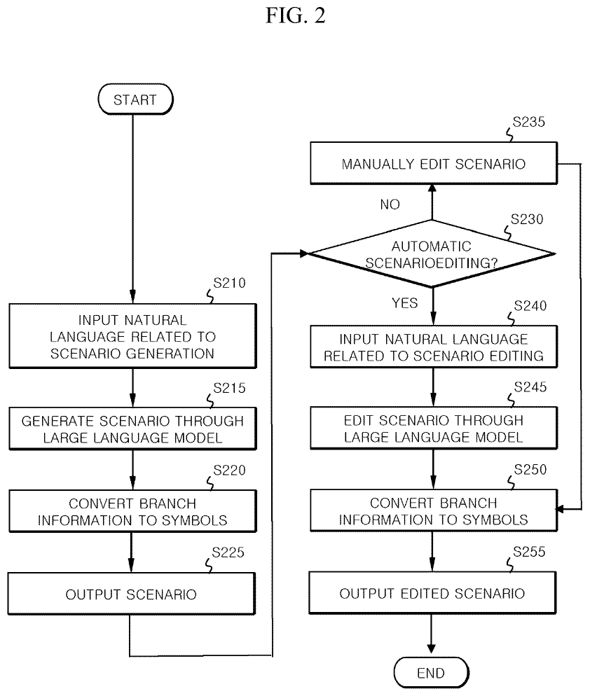

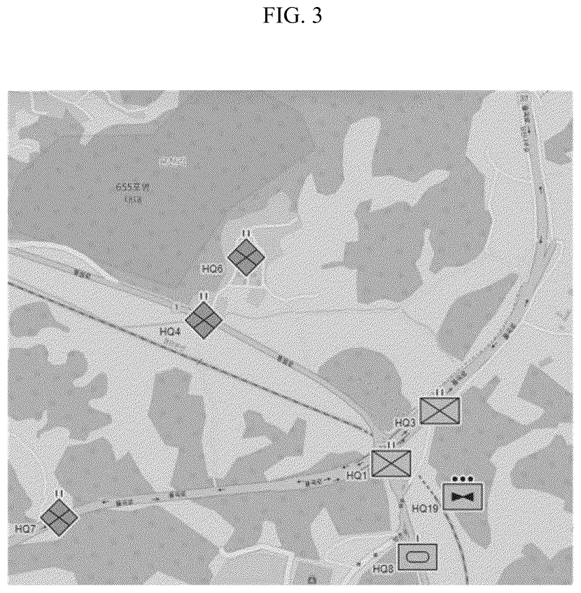

FIG. 1 is a configuration diagram of an apparatus for automatic generation of military scenarios according to one embodiment of the present disclosure, FIG. 2 is a flowchart of a method for automatic generation of military scenarios according to one embodiment of the present disclosure, and FIG. 3 is a diagram illustrating a military scenario generated by the apparatus for automatic generation of military scenarios according to one embodiment of the present disclosure.

Referring to FIG. 1, an apparatus 100 for automatic generation of military scenarios according to one embodiment of the present disclosure may include an input unit 110, a scenario generation unit 120, a scenario editing unit 130, a symbol conversion unit 140, and an output unit 150.

The input unit 110 may be implemented with input devices such as keyboards, mice, microphones, and scanners, and with data storage and transmission devices such as USB memory, external hard drives, and memory cards. Through these devices, at least one of scenario information, force information, regional information, or event information, which are components of a military scenario according to one embodiment of the present disclosure, may be received as natural language input from a user and transmitted to the scenario generation unit 120 or the scenario editing unit 130. The natural language may include paragraphs, sentences, clauses, phrases, or words (see S210).

Among the components of a military scenario, scenario information refers to bibliographic data. For example, the scenario information may include the title, description, author, creation date, and the like of the military scenario.

In addition, among the components of a military scenario, force information refers to information about the forces participating in the scenario. For example, force information may include details such as the names, types, roles, and resources of the participating forces, and more specifically, may include information such as the type, composition, branch, location, and status of units as the constituent elements of each force. The force information may also include information regarding the goals and tasks of each force and its subordinate units, the conditions for achieving those goals, and the criteria for success or failure.

In addition, among the components of a military scenario, regional information refers to information about the region where the military scenario takes place. For example, regional information may include maps, boundaries, major terrain features, weather, and the like.

In addition, among the components of a military scenario, event information refers to information about events in the scenario. For example, event information may include major scenario events, the timing of events, the start and end times of the military scenario, time zones, and the like.

The scenario generation unit 120 may generate a military scenario in a preset format, for example, Military Scenario Definition Language (MSDL), which is a standardized XML format, by applying a large language model to at least one of the scenario information, the force information, the regional information, or the event information transmitted from the input unit 110 (see S215).

The scenario editing unit 130 may edit the military scenario by applying the large language model to editing information regarding at least one of the scenario information, the force information, the regional information, or the event information received from the input unit 110 (see S230 to S255).

In one embodiment, a user may select whether to edit the military scenario automatically or manually in the scenario editing unit 130 (see S230).

If the user selects automatic editing, the scenario editing unit 130 may receive, from the input unit 110, editing information regarding at least one of the scenario information, the force information, the regional information, or the event information that the user has input (see S240).

The scenario editing unit 130 may then edit the military scenario using the large language model based on the received editing information (see S245).

Before the editing of military scenarios is performed, the scenario editing unit 130 may restructure the MSDL representation of the military scenario, using methods such as data format conversion and information compression, in order to optimize the scenario for editing when it exceeds the maximum token limit of the large language model.

For reference, the large language model according to one embodiment of the present disclosure, used by the scenario generation unit 120 and the scenario editing unit 130 to generate and edit military scenarios, is a large language model fine-tuned using military-related information such as military terminology dictionaries, military manuals, and military news, to optimize it for military scenario generation and editing.

Meanwhile, when the user selects manual editing, the user may directly manipulate components of the military scenario in the scenario editing unit 130, in a manner adapted from existing military simulations (see S235).

Additionally, selecting either the manual editing method or the automatic editing method does not preclude the use of the other. The user may switch between the two methods at any time during editing.

The symbol conversion unit 140 may use a symbol search model to convert unit branch information included in the force information of the military scenario into symbols based on a preset specification corresponding to the unit branch information.

For example, if the generated military scenario includes unit branch information in the force information, the symbol conversion unit 140 may automatically assign symbols based on a preset specification, such as symbols according to MIL-STD-2525D, using a symbol search model based on a Bidirectional Encoder Representations from Transformers (BERT)-based model. The user may also manually designate symbols (see S220).

For reference, the BERT-based model according to one embodiment of the present disclosure is trained on data in which pairs of branch words and similar standard symbol words (e.g., those based on MIL-STD-2525D) are labeled as “positive,” and pairs of branch words and dissimilar standard symbol words are labeled as “negative.”

The symbol search model may measure the similarity between branch words and standard symbol words using branch word vector data.

For example, the symbol search model may calculate similarity based on distances between vectors in branch vector data, where terms such as “mechanized infantry” and “motorized infantry,” which are similar to “infantry,” are located in nearby vector spaces, while terms such as “unmanned aircraft” and “rotary-wing aircraft” are located in more distant vector spaces. In this way, “infantry” and “mechanized infantry” are classified as having high similarity, whereas “infantry” and “unmanned aircraft” are classified as having low similarity.

In addition, when unit branch information of a military scenario has been edited, the symbol conversion unit 140 may automatically modify existing symbols into symbols based on a preset specification, such as MIL-STD-2525D, corresponding to the unit branch information of the edited military scenario, through the symbol search model. The user may also manually modify the symbols (see S250).

The output unit 150 may visualize and output the scenario information, force information, regional information, and event information of military scenarios in real time through a UI (see S225).

The output unit 150 may further visualize and output the military scenario being edited in real time through the UI (see S255).

If there is no regional information in the military scenario, the output unit 150 may output a UI including, for example, information tables organizing the branches, types, compositions, and goals of units belonging to each force in table format, bar graphs or pie charts visualizing the number of troops, equipment, and the like of units, and progress charts showing goal achievement status.

Meanwhile, when regional information is present in the military scenario, the output unit 150 may output a UI including, for example, a map. If additional unit branch information and unit location information are present, the output unit 150 may output a map, such as that shown in FIG. 3, in which unit symbols are displayed at coordinates corresponding to locations, and detailed information of the corresponding units may be displayed in popups when the symbols are clicked.

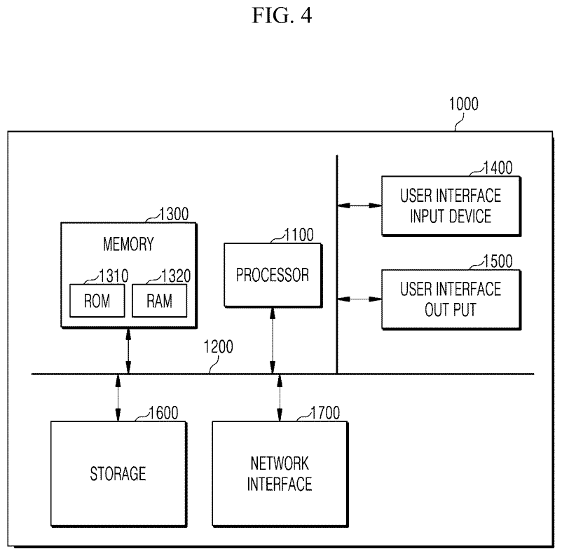

FIG. 4 is a diagram showing a computing system according to one embodiment of the present disclosure. One or more controllers, processors, or the like, such as the apparatus 100, the input unit 110, the scenario generation unit 120, the scenario editing unit 130, the symbol conversion unit 140, or the output unit 150, may be implemented in or as part of a computing system.

A computing system 1000 may include at least one processor 1100, a memory 1300, a user interface input device 1400, a user interface output device 1500, a storage device 1600, and a network interface 1700 connected through a bus 1200. The processor 1100 may be a central processing unit (CPU) or a semiconductor device that executes instructions stored in the memory 1300 and/or the storage device 1600. The memory 1300 and the storage device 1600 may include various types of volatile or non-volatile storage media. For example, the memory 1300 may include a read only memory (ROM) 1310 and a random access memory (RAM) 1320.

Accordingly, steps of the methods or algorithms described in connection with embodiments disclosed in this specification may be directly implemented in hardware, software modules, or a combination thereof executed by the processor 1100. The software modules may reside in storage media (i.e., the memory 1300 and/or the storage device 1600) such as RAM, flash memory, ROM, EPROM, EEPROM, registers, hard disks, removable disks, or CD-ROMs. An exemplary storage medium may be coupled to the processor 1100, and the processor 1100 may read information from, and write information to, the storage medium. Alternatively, the storage medium may be integrated with the processor 1100.

The processor and the storage medium may reside within an application specific integrated circuit (ASIC). The ASIC may reside within a user terminal. Alternatively, the processor and storage medium may reside as individual components within the user terminal.

As used in the present disclosure (especially in the appended claims), the terms “a/an” and “the” include both singular and plural references, unless the context clearly states otherwise. Also, it may be understood that any numerical range recited in the present disclosure is intended to include (e.g., all) sub-ranges subsumed therein (unless indicated otherwise) and accordingly, the disclosed numeral ranges include (e.g., every) individual value between the minimum and maximum values of the numeral ranges.

The method according to the present disclosure may be performed in an appropriate order unless a specific order is described or otherwise specified. That is, the present disclosure is not limited to the order in which the steps are recited. All examples described in the present disclosure or the terms indicative thereof (“for example”, “such as”) are merely to describe the present disclosure in greater detail. Therefore, it should be understood that the scope of the present disclosure is not limited to the example embodiments described above or by the use of such terms unless limited by the appended claims. Also, it may be apparent to those skilled in the art that various modifications, combinations, and alternations may be made depending on design conditions and factors within the scope of the appended claims or equivalents thereof.

The present disclosure is thus not limited to the example embodiments described above, and rather the present disclosure is intended to include the claims, and modifications, equivalents, and alternatives falling within the spirit and scope of the appended claims.

What is claimed is:

1. An apparatus for automatic generation of military scenarios, comprising a scenario generation unit configured to generate a military scenario in a preset format by applying a large language model to at least one of scenario information, force information, regional information, or event information.

2. The apparatus of claim 1, further comprising a scenario editing unit configured to edit the military scenario by applying the large language model to editing information regarding at least one of the scenario information, the force information, the regional information, or the event information.

3. The apparatus of claim 1, further comprising a symbol conversion unit configured to, using a symbol search model, convert unit branch information included in the force information of the military scenario into symbols based on a preset specification corresponding to the unit branch information.

4. The apparatus of claim 1, wherein the preset format is an MSDL-based standard format.

5. A method for automatic generation of military scenarios, comprising generating a military scenario in a preset format by applying a large language model to at least one of scenario information, force information, regional information, or event information.

6. The method of claim 5, further comprising editing the military scenario by applying the large language model to editing information regarding at least one of the scenario information, the force information, the regional information, or the event information.

7. The method of claim 5, further comprising, using a symbol search model, converting unit branch information included in the force information of the military scenario into symbols based on a preset specification corresponding to the unit branch information.

8. The method of claim 5, wherein the preset format is an MSDL-based standard format.

9. An apparatus for automatic generation of military scenarios, comprising:
a memory including instructions; and
a processor configured to, by executing the instructions, generate a military scenario in a preset format by applying a large language model to at least one of scenario information, force information, regional information, or event information.

10. The apparatus of claim 9, wherein the processor is configured to edit the military scenario by applying the large language model to editing information regarding at least one of the scenario information, the force information, the regional information, or the event information.

11. The apparatus of claim 9, wherein the processor is configured to, using a symbol search model, convert unit branch information included in the force information of the military scenario into symbols based on a preset specification corresponding to the unit branch information.

12. The apparatus of claim 9, wherein the preset format is an MSDL-based standard format.
